(19) United States
(12) Patent Application Publication
(10) Pub. No.: US 2024/0273964 A1
(43) Pub. Date: Aug. 15, 2024

(54) SYSTEM AND METHOD OF LABELING AND WEIGHING GOODS

(71) Applicant: Trade Fixtures, LLC, Little Rock, AR (US)

(72) Inventors: Christopher Lyons, Western Springs, IL (US); Craig Pavlich, Glen Ellyn, IL (US)

(73) Assignee: Trade Fixtures, LLC, Little Rock, AR (US)

(21) Appl. No.: 18/564,952

(22) PCT Filed: May 27, 2022
(86) PCT No.: PCT/US2022/031308

§ 371 Date: Nov. 28, 2023

Related U.S. Application Data
(60) Provisional application No. 63/194,576, filed on May 28, 2021.
(60) Provisional application No. 63/195,988, filed on Jun. 2, 2021.

(51) Int. Cl. G07F 13/04; A47F 1/035; G07F 9/00

(52) U.S. Cl. CPC G07F 13/04; A47F 1/035; G07F 9/00

(57) ABSTRACT

A gravity-feed dispensing system includes a hopper configured to hold a bulk material for dispense. A hopper identifier encodes an identification of the bulk material in the hopper. A valve of a gravity feed dispenser is operable by an actuator assembly between open and closed conditions to selectively permit bulk material to pass from the hopper into a consumer receptacle. A controller is configured to receive an indication of a dispense of bulk material from the hopper and to receive the identification of the bulk material in the hopper. A retail endpoint is configured to receive the indication of a dispense and the identification of the bulk material in the hopper and configured produce a sale indicator from the indication of the dispense and the identification of the bulk material in the hopper.

### CROSS-REFERENCE TO RELATED APPLICATIONS

The present application claims priority of U.S. Provisional Patent Application No. 63/194,576, filed on May 28, 2021, the contents of which is incorporated by reference herein in its entirety. The present application claims priority of U.S. Provisional Patent Application No. 63/195,988 filed on Jun. 2, 2021, the contents of which is incorporated by reference herein in its entirety.

### BACKGROUND

The present disclosure relates to the field of bulk dispensing bins, particularly those for use by consumers at point-of-sale installations. More specifically, the present disclosure relates to features for weighing and labeling bulk dispensed items.

Bulk dispensers, and more particularly gravity-feed bulk dispensers are known and used in commercial settings for self-service portioning of bulk materials, for example foods. Traditionally, gravity feed bins for dispensing bulk materials are used to dispense a wide variety of materials having a range of sizes and aggregate make-ups as diverse as hardware components (e.g. nuts and bolts) or food (e.g. nuts, cereals, grains, pastas, coffee (beans or ground), dried soup mix, candies, spices). Generally, the bins include an enclosure having an inlet at an upper end through which the enclosure is filled, an outlet at a lower end for dispense of the material, and a flow control device located between the upper and lower openings for controlling the amount of materials being dispensed. In operation, as the material is being dispensed gravity pulls the remaining material in the enclosure towards the lower end to replace dispensed material. These types of bins generally include a downwardly curving inner wall that forms a chute to channel the dispensed materials in a receptacle adjacent the outlet.

Examples of known gravity feed bins are found in U.S. Pat. No. 4,903,866 entitled, “Gravity Dispensing Bin System”; U.S. Pat. No. 5,437,393, entitled, “Apparatus for Delivering Bulk Foods”; U.S. Pat. No. 6,182,864 entitled, “Bulk Food Dispensing Apparatus”; U.S. Pat. No. 6,241,123 entitled, “Bulk Food Dispensing Apparatus”; U.S. Pat. No. 10,450,152 entitled, “Expandible Gravity-Feed Bin”; and US Pat. App. Pub. No. 2019/0092617 entitled, “Expandible Gravity-Feed Bin.” Each of these are incorporated by reference in their entireties.

### BRIEF DISCLOSURE

An example of a gravity-feed dispensing system includes a hopper configured to hold a bulk material for dispense. The hopper includes a hopper identifier. The hopper identifier encodes an identification of the bulk material in the hopper. A gravity-feed dispenser includes a valve operable by an actuator assembly between open and closed conditions to selectively permit bulk material to pass from the hopper into a consumer receptacle. A controller is configured to receive an indication of a dispense of bulk material from the hopper. The controller is configured to receive the identification of the bulk material in the hopper. A retail endpoint is configured to receive the indication of a dispense and the identification of the bulk material in the hopper and configured produce a sale indicator from the indication of the dispense and the identification of the bulk material in the hopper.

In further examples of the gravity-feed dispensing system, the controller determines an estimated dispense amount and an estimated dispense cost. The identification of the bulk material in the hopper includes a material density and a unit price. The retail endpoint includes a scale configured to measure a weight of the bulk material in the consumer receptacle. The sale indicator includes the weight of the bulk material. The sale indicator includes the identification of the bulk material and a sale price. The retail endpoint includes a labeling station. The labeling station prints a label for the consumer receptacle with the sale indicator. The retail endpoint includes an endpoint graphical display configured to visually present the indication of the dispense, the identification of the bulk material, and the sale indicator. The hopper includes a hopper RFID tag that is encoded with the identification of the bulk material within the hopper. The consumer receptacle includes a receptacle RFID tag. The gravity feed dispenser includes a sensor configured to detect an operational state of the valve. The controller is communicatively connected to the sensor and the operational state of the valve is the indication of a dispense of bulk material from the hopper. The valve is configured to dispense a nominal fixed volume of bulk material. The retail endpoint is configured to write the sale indicator to the receptacle RFID tag. The dispenser is configured to write to the receptacle RFID tag to encode the receptacle RFID tag with the identification of the bulk material.

### BRIEF DESCRIPTION OF THE DRAWINGS

FIG. 1 is a system diagram that depicts an example of a system for bulk dispensing.

FIG. 2 depicts a first example of a system and method for bulk dispensing.

FIG. 3 depicts a second example of a system and method for bulk dispensing.

FIG. 4 depicts a third example of a system and method for bulk dispensing.

FIG. 5 depicts a fourth example of a system and method for bulk dispensing.

FIG. 6 is a detailed diagram of a portion of FIG. 1.

### DETAILED DISCLOSURE

Regulation governing goods transactions require certification of weights and measures for commercial trade. Functionally, this requires retailers to maintain audited systems for measuring items, and traditionally in bulk retailing, mass has been utilized as the unit of evaluation (as opposed to volume), requiring NTEP certified calibrated scales to associate price-per-unit to the number of (mass) units being purchased. In a traditional retail bulk shopping setting then, the customer must select the product and estimate the amount to dispense. Note that in most current retail layouts, a weight measurement or estimate cannot be made until after product is dispensed (via a nearby estimation scale). Typically, the customer must personally calculate the estimated final price, by associating the price-per-unit (e.g. pound) with the number of units dispensed. The retailer must then repeat this process, by officially weighing the item on a ‘legal-for-trade’ scale and then correctly associating the item identity and its weight to its price per unit weight to arrive at the official price for the bulk goods.

After recognizing the above, the inventors have sought to develop devices, systems, and methods as described herein to overcome some or all of the following challenges identified by the inventors. Consumers may experience difficulty estimating the amount (weight, volume, and/or price) from a bulk dispenser. Customers or the retailer may improperly associate a bulk dispensed item to a different product. Mis-identification could result in either an unexpected cost to the customer or uncounted losses of higher valued products by the retailer.

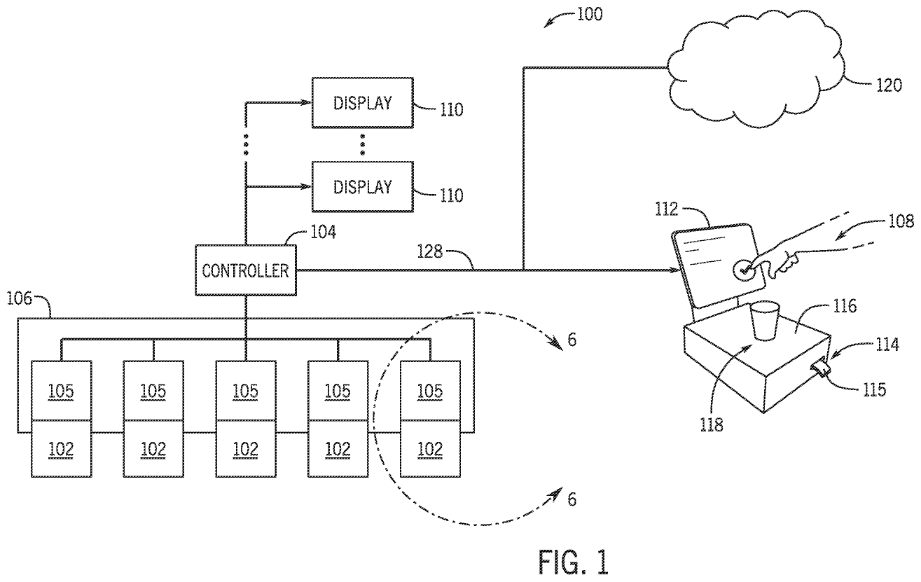

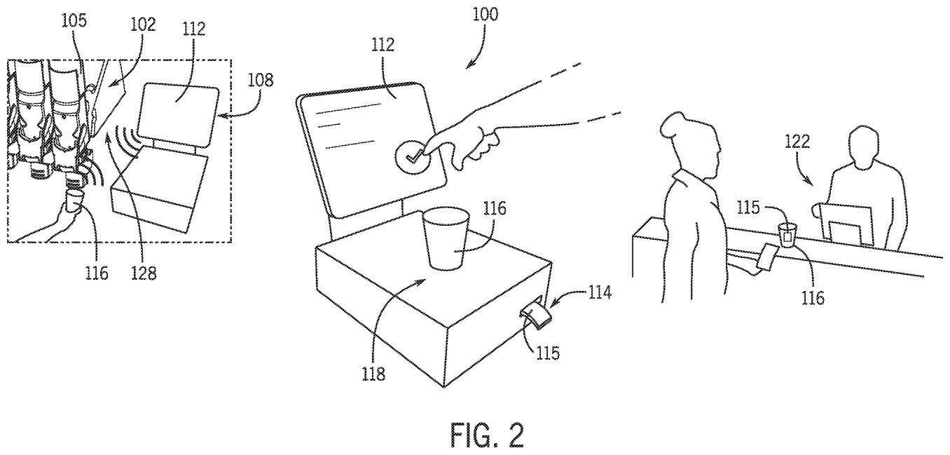

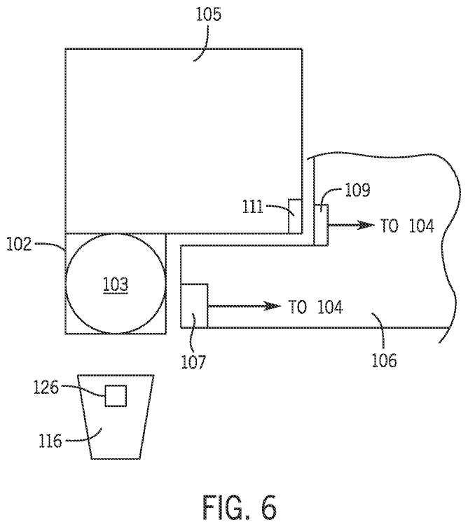

FIG. 1 is a system diagram that depicts an example of a system for bulk dispensing, weighing, and labeling. It will be recognized that FIG. 1 is presented merely for descriptive purposes and that various embodiments of the disclosure may include a portion or some of the features as described herein, or additional features, while remaining within the scope of the present disclosure. FIG. 6 is a detailed diagram of an example of a portion of the system of FIG. 1 as noted by line 6-6. It will be recognized that the features as shown and described with respect to FIGS. 1 and 6 are merely exemplary and more or fewer components may be used within the scope of the present disclosure and/or the implementation of any of the further examples shown and described herein, including in FIGS. 2-4. FIG. 1 presents a system 100 of retail bulk material dispensing and sale. The system 100 includes a plurality of bulk dispensers 102, for example as disclosed in the reference above, but also as will be described in further detail herein.

Examples of the system 100 may use any of a variety of bulk dispensers 102. The bulk dispensers 102 may be those as known in the art, for example those as noted above. Bulk dispensers 102 may be gravity feed dispensers. A bulk dispenser 102 holds the bulk material, which may be bulk food products, for example but not limited to nuts, grain, dried fruit, candies, granola, flours, or cereals, in a hopper 105. Bulk dispensers operate to dispense through a valve 103 metered or portioned amounts of bulk material from the hopper 105. The hopper 105 may be integral with the dispenser 102 and the valve 103, or the hopper 105 may be separable therefrom as discussed in further detail herein. The consumer possesses a consumer receptacle 116 to receive the metered or portioned amount of bulk material. The consumer receptacle 116 in the possession of the consumer may, for example, be a bag, jar, cup, or box. Consumer receptacles may be standardized and provided to the consumer at the bulk dispensers 102, or the receptacles 116 may already be in the possession of the consumer and brought by the consumer to the dispenser 102 for filling. As will be described herein, in some examples, the consumer receptacle 116 may include an RFID tag 123 or other identification tag.

Bulk dispensers 102 may be automated with an electro-mechanical actuator that opens a dispenser valve upon a receptacle 116 in the possession of a consumer being detected in a correct proximity of the bulk dispenser 102. In other examples, the dispenser 102 uses a mechanical actuator for the valve, to operate the dispenser valve 103 to dispense the bulk material into the receptacle 116. The mechanical actuator may be configured to be physically operated by a user for example by contact with the user's hand or in which the user contacts the actuator of the dispenser 102 with the receptacle 116 to provide a barrier against common touch contact areas. In such an example of a dispenser that uses a mechanical actuator, the system 100 may include a sensor 107 associated with each of the dispensers, for example, embedded in, connected to, or integrated within a fixture 106 which supports the dispenser 102. The sensor 107 may operate to detect each instance of an operation of the valve 103, and to provide a signal representative of an operational state of the valve 103. The sensor 107 may be a proximity sensor that detects the presence or movement of a portion of the mechanical actuator or the valve 103. The mechanical actuator or the valve 103 may incorporate a detectable element to aid sensing by the sensor 107. A proximity sensor may be a capacitive proximity sensor. Other examples of sensors include optical, Hall effect, magnetic field, reed switch, density, or contact sensors. Contact sensors may include limit switches, load cells, or resistive pressure sensors. Optical sensors may include a laser, IR, or visible light spectrum ranging or line break sensor. In a further example of an optical sensor, the optical sensor is configured to detect the bulk material exiting the dispenser or moving within the dispenser. Other sensors that produce signals indicative of the operation of the mechanical actuator or valve 103 will also be recognized based on this disclosure.

The dispenser valve may exemplarily be a gate. However, it will be recognized that the valve may be embodied in a variety of other components, any of which are within the scope of the present disclosure. The valve may be any component of the dispenser that operates to control the start, stop, or other metering of the flow of the bulk product held within the dispenser. The valve controls the ejection of the bulk product at a rate that is suitable for delivery to the customer. The valve is configured to do so with minimal lag time between starting and stopping the bulk product dispense and do so with minimal leakage of the bulk material when the valve is in the closed position. The valve generally may operate according to one of two different valve configurations: a fixed displacement valve or a flow metering valve. In examples, valves of either of these two configurations may include the same or similar components, yet arranged to operate in one of these configurations.

In a fixed displacement valve system, a chamber of a defined volume is alternatively opened and closed such that a constant fixed volume of material is sequentially trapped/portioned and then released with each successive operation of the valve. Each fixed displacement valve system segregates a portion of the bulk material from the stored material as a whole and dispenses sequential increments of these segregated portions. These sequential increments of portions may be used to estimate and/or monitor the amount of the bulk material that has been dispensed. The valve system may be designed to repeatably produce a portion of a known volume. Fixed displacement systems may include any of a variety of mechanical systems.

A bi-gate system includes an input gate and an output gate defining a chamber there-between. First, the input gate is opened while the output gate remains closed, until the chamber is filled to the desired measured level. This level may be defined by the volume of the chamber in which the chamber is configured to fill to a particular volume. Secondly, the input gate is closed while the output gate is opened, to evacuate the chamber and dispense the portioned product. In examples, the input gate and the output gates may be separate gating structures, or in other examples, the input gate and the output gates may be portions of a single gating structure.

A combined gate system incorporates the input gate and the output gate, as described above, into a single moving part. Such a system functions the same as the bi-gate system as described above, except the two gates are moved as a pair in a single motion under the same actuation. In some examples of such a system, both gates may both momentarily exist in a transitional state, wherein both gates are partially open, however, the geometry of the system is such that no significant leakage past both the input gate and the output gate during a single movement occurs.

A rotary gate system operates functions similarly to the bi-gate and combined gate systems as described above, however the gate system revolves to position between open and closed positions of the input gate and the output gate. This is exemplarily contrasted with a reciprocal pivot as may be used to move the bi-gate or the combined gate as described above.

A screw system may use a rotary motion of a screw to draw bulk material axially along the length of the screw, pushed by the flight or flights of the screw. The spacing between the flight(s) define individually trapped volumes which are dispensed with reach rotation of the screw.

In a flow metering valve system, the valve is positioned between the container or compartment holding the bulk material and the outlet of the dispenser. The valve defines an orifice with a controllable area through which the bulk material can flow to the outlet. The open area of the valve controls the rate at which the bulk material flows to the outlet. The valve can be movable between open and closed positions or may be continuously adjusted between fully open and fully closed positions. Flow metering valve systems may exemplarily be used to compute volume and mass from a calibration-based and/or formula-based flow rate and duration calculation. The flow rate may be derived from a determination of the orifice area size (which may be determined based upon a detected or known position of the valve). A known or measured upstream pressure, weight, or volume of bulk material above the valve is used along with the orifice area size to determine the flow rate. A calibration technique and/or model equations and/or experimentally derived lookup tables for various bulk materials and/or conditions may be used to calculate the flow rate. Measurement of the volume or mass of the bulk material held within the dispenser may be further used in adjustment factors or formula variables in further calculations of the bulk material flow rate.

Flow metering valve systems may be implemented with any of a variety of structures, including with the examples provided herein. Gate valves may include a plate or door which is moved (e.g. raised or lowered) transverse to the outlet. A ball valve may be a cylindrical, elliptical, or spherical element with a cutout in the valve body, which as the valve body rotates within a valve housing, the orifice area through the valve is changed. A butterfly valve includes a plate of arbitrary shape that may be rotated via a shaft such that the plate is positioned into more axial alignment with the outlet (open) or more transverse across the outlet (closed). An iris valve includes a plurality of plates which are connected to move in a coordinated fashion to radially change the open cross-sectional area of the orifice.

As further described herein the dispenser 102 is communicatively enabled such that data is communicated to a controller 104 regarding the use and/or operation of each of the dispensers 102. As will be described in further detail herein, such detection and communication systems may be separate from, but associated with each of the dispensers, for example detection and communication systems embedded in the fixture 106 e.g shelf which supports the dispensers 102. In other examples, electronics may be integrated with the dispenser, or may be removably coupled to the dispenser, such as to facilitate cleaning and maintenance of the dispensers 102 separate from the electronics. The use and/or operation data is provided to the controller 104, which is exemplarily a single board computer (SBC) comprising a microprocessor and other electrical components and circuitry such as to configure the controller 104 to receive the signals with use and/or operational data regarding each of the dispensers 102. The data may exemplarily include signals that indicate when each dispenser 102 enters an open condition and/or a closed condition. The communicative connections may include wired and/or wireless connections to the controller 104.

The fixture 106 supports and positions the dispenser 102 within the retail setting. Additionally, in examples, the fixture 106 may facilitate the integration of electronics into the system 100, for example whereby the electronics are incorporated into the fixture 106, while the dispenser remains a mechanical device to improve sanitation, cleaning, maintenance, and replacement of individual dispensers 102. The fixture 106 may further include the controller 104 and/or communication infrastructure (e.g. electrical power and electrical data communication) ports, contacts, and wires to enable the communication of the use and/or operation data to the controller 104 or communication of other data and instructions to other components of the system 100 as described herein. In a non-limiting example, the fixture 106 may define a plurality of locations or increments to which the dispenser 102, or a hopper 105 connected to the dispenser 102 may connect to secure to the fixture 106 at a defined location. The fixture 106 may include a plurality of communication elements 109 configured at the dispenser 102/hopper 105 locations. The hoppers may include a hopper identifier 111 which encodes information regarding the hopper 105. This may include, but is not limited to, an identification of the bulk material in the hopper, an initial volume of the hopper, a unit price, a bulk material density, or an owner of the hopper 105. In examples, the encoded information may be an ID or reference number which may be used by the controller 104 to reference a lookup table that includes some or all of the above information. Such lookup table may be implemented as a database accessible by the controller 104 over network, which may be the retail data network 120. In examples, the hopper identifier may be an RFID or NFC tag, or may be electrical or physical features encoding information. The communication elements 109 are configured to communicate and/or receive the encoded information in the hopper identifier 111. The physical connection of the dispenser 102 or the hopper 105 to the fixture 106 may further establish an electrical and/or communicative connection between hopper identifier 111 and the communication element 109 and/or any electronic components of the dispenser 102 and the fixture. For example, electrical contacts may be connected when the dispenser is secured to the fixture. In other example, radio frequency, optical, or other wireless communication connection may be made between the dispenser and the fixture, including using a WI-FI or BLUETOOTH communication protocol.

The controller 104 receives the use and/or operation data, for example from sensor 107 or communication element 109, and analyzes the data, for example by executing computer-readable code stored on a computer-readable medium and accessible by the controller, and upon execution of the computer-readable code, the controller processes the data to carry out the functions as described in further detail herein. In examples, the controller 104 may identify a transition between dispenser condition states, e.g. closed or open conditions of the dispenser, or may identify a bulk product associated with the dispenser, the controller 104 may further operate to control one or more graphical displays 110 as described herein and to communicate with a retail endpoint 108 as described in further detail herein. Within examples provided herein, the retail endpoint may include retail shopping-related transaction or data systems which may include, but are not limited to, a display, a scale, a cash register, a mobile app, a website, a retail network, or an internet account.

The controller 104 can operate to present an estimated dispense summary on one or more graphical display 110 of the system. As will be described in further detail herein, in an example, one or more graphical displays 110 are centrally located to a plurality of dispensers 102. In a further example, a graphical display 110 is associated by proximity, and in an example, physical connection, to a single dispenser 102 of the plurality. That is, each dispenser 102 is associated to its own graphical display 110. Power and communicative connections to the graphical displays 110 may be provided within the fixture 106.

The controller 104 may operate to produce an estimate of the amount of dispensed bulk material based upon analysis of data provided by the dispensers 102, and the controller 104 may further operate the one or more graphical displays 110 to visually present the estimated dispensed amount and an estimated cost of the dispensed amount. The graphical displays 110 may further be operated by the controller 104 to present an identification of the bulk material within the dispenser, a volumetric or by weight costs of the bulk material, and/or a dispense portion size or flow rate.

The controller 104 may be informed by information stored on a computer readable medium such information may include an identification of type of dispenser actuation (fixed volume or continuous flow), an identification of the bulk material, a portion volume/flow rate of the bulk material, a density or other physical property of the bulk material and a unit price of the bulk material for each of the dispensers 102 in the system 100. As noted above, the controller 104 may further receive a user input, for example, though the graphical display or by RFID or NFC communication, or example with an RFID or NFC tag of the hopper identifier 111 of the hopper 105 or other packaging for the bulk material loaded to the dispenser 102 to inform the controller 104 of the identity of the bulk material. This information may include a product look-up (PLU) number and/or a stock keeping unit (SKU) number that identifies the bulk material.

If the dispenser 102 is known by the controller to be a fixed volume dispenser, then the controller 104 counts detected actuations of the valve 103 from the sensor 107 and multiplies that count by the portion volume to produce an estimated dispense amount. The estimated dispense amount is multiplied by the unit price to arrive at an estimated cost. In an example, the bulk material information may include a material density which may be used by the controller to first calculate an estimated dispense weight and then the estimated cost. In an example, this information may be presented on a graphical display 110 individually associated to the dispenser, and may increment and update each time the customer actuates the dispenser to dispense another portion into the consumer receptacle 116.

If the dispenser 102 is known by the controller to be a continuous flow dispenser, then the controller 104 determines a length of time that the dispenser 102 is in the open condition. The controller 104 multiplies the determined length of time by the flow rate of the bulk material for that dispenser to arrive at an estimated dispense volume. The estimated dispense volume is multiplied by the unit price for the bulk material to arrive at the estimated price. As noted above, the bulk material information may include a material density which may be used by the controller to first calculate an estimated dispense weight and then the estimated cost. Both the estimated volume and the estimated price are visually presented on the graphical display 110 associated to the dispenser 102. In an further example, the graphical display 110 may update intra-dispense as the controller 104 continuously measures the ongoing length of time of the dispense.

In either case, dependent upon the exact retail setting, the estimated amount and estimated price may not be sufficient to comply with retail pricing rules or regulations. The controller 104 may further be communicatively connected to a retail endpoint 108, which may exemplarily include a scale 118 and a labeling device 114. The scale 118 may operate to provide a marketable measure of the bulk material so that an official sale price can be determined. The labeling device 114 operates to provide a sale indicator which enables furtherance of the checkout or payment process. The sale indicator as described herein ties the consumer receptacle 116 of bulk material to the checkout or payment process. The retail endpoint 108 may be incorporated into the fixture 106 with the dispensers 102, may be a stand-alone kiosk, or may be integrated in to the final point of sale, for example, a staffed cash register, or an automated checkout. Examples of these are provided herein. In a still further example, some or all of the functionality of the retail endpoint 108 is provided in connection with a smartphone and a mobile app.

In the example of only a retail endpoint 108 that only include a labeling device 114, each time the controller 104 identifies a dispense from a dispenser, the controller 104 provides an indication of the dispense to the labeling device 114 of the retail endpoint 108. The retail endpoint 108 may include a graphical display 112 that visually presents a list of the dispensers and associated bulk materials that have been dispensed within the system 100. The customer can select their bulk material from the list and the labeling device 114 produces the sale indicator to tie the identified bulk material to the consumer receptacle 116. The labeling device 114 may be a label printer operable to print an identification label which may include an SKU, PLN, bar code, or QR code identifying the bulk material. This coordination between the dispensers and the label printer through the controller 104 can help customers properly identify the bulk materials dispensed and thwart customer substitution of a label for a lower cost, but similar-looking, bulk material. In an alternative example wherein the consumer receptacle 116 includes a writable RFID tag 126, the labeling device 114 may be an RFID writer that writes the information to the RFID tag 126 on the consumer receptacle 116 as the sale indicator.

Relatedly, when the retail endpoint 108 further includes a scale 118, giving it weighing functionality, the customer is similarly presented with a list of the recent bulk material dispenses (e.g. those which have not yet been weighed or labeled) as supplied by the controller 104 to the graphical display 112, from which the customer selects their bulk material. The list on the graphical display 112 may further include the estimated amount to better help the customer identify their bulk material line item from the list on the graphical display 112. Once the bulk material is selected, the consumer receptacle 116, filled with dispensed bulk material, can be weighed using the scale 118, and a label 115 printed by the labeling device 114114 that identifies the bulk material and the marketable weight and price.

The controller 104 is further communicatively connected to a retail data network 120. The retail data network 120 may exemplarily be for a single store, for a region of stores, or a national data network. The retail data network 120 may be a networked computer or server that collects the data sent to the network 120 by the controllers 104 located within the network. The retail data network 120 may further include information technology tools or applications to facilitate management, organization, and/or sorting of the data to provide retail insight into the operation and use of the bulk dispensers. The retail data network 120 receives and gathers the dispense data determined by the controller 104 (e.g. bulk material identification and amount) along with other retail-informative information including but not limited to time and/or date of dispense, any ongoing sales promotions, or location of the dispenser within the fixture. This information provided to the retail data network enables the identification of trends or changes in trends surrounding customer purchases of bulk materials, which can better inform the customer experience, dispenser layout, or bulk material supply chain decisions.

In a still further example, the controller 104 and/or the retail data network 120 can use the detected actuations of the respective dispensers to provide an estimation of remaining volume in the hopper 105 of each dispenser 102. This estimation can be based upon the same dispense volume estimations as described above with respect to fixed volume or continuous flow dispensers. In examples, the controller 104 and/or the retail data network 120 starts with the estimated initial volume of the bulk material in the dispenser. With each detected dispense, the controller and/or the retail data network 120 decrements the estimated dispense volume from the estimated initial volume. As the estimated remaining bulk material in the dispenser depletes, a stocking notice may be provided to a store inventory manager or personnel responsible for refilling the dispenser. In examples, a signal may be provided back to an associated graphical display 110 to provide a visual indication on the graphical display that the dispenser is running low of bulk material.

An estimated initial volume can be provided to the controller and/or the retail data network in a number of ways, examples of which are disclosed herein. In one example, the hopper of the dispenser is a removable and replaceable hopper with a defined volume of bulk material. When a depleted hopper is replaced with a filled hopper an input is made to the system, for example through a button or touch input associated with the graphical display to indicate that a newly filled hopper has been loaded onto the dispenser. The controller 104 and/or the retail data network 120 exemplarily has access to stored data identifying the volume of the replaced filled hopper and begins decrementing dispenses from this stored value. Similarly, the new hopper may include a barcode which is scanned when the hopper is replaced on the dispenser, the scanning input indicative of a hopper replacement and information encoded in the barcode can identify details of the bulk material in the hopper, for example, an identification or an initial volume in the hopper. The barcode scanner may be integrated with or connected to the fixture. In another example, the replaceable hopper is self-identifying, for example by an RFID tag that is readable by an RFID reader, for example, located in the fixture which identifies that the hopper has been replaced and such RFID may encode additional information regarding the contents of the hopper and/or the estimated initial volume of the hopper. In another example, the hopper includes an identifying physical feature, for example an array or series of electrical pins or contacts which encode an identification of the hopper. The controller 104, having received an identification of the hopper, can reference stored data regarding the hopper volume, bulk product identity, bulk product density, estimated total number of dispense cycles before depletion, or unit price to use as described herein. In an example, the controller 104 determines that a new hopper has been connected to the dispenser and resets a count or estimate of remaining dispenses before stock out of the bulk product in the hopper.

In another example, the hopper 105 may be fillable-in-place, but also include graduations, for example on an interior surface of the hopper. While the hopper may be refilled with bulk material, a worker may take note of the graduation associated with the filled hopper and enter this volume graduated estimate to the controller 104 and/or the retail data network 120.

FIGS. 2-5 presented herein provide additional non-limiting examples of implementations of the system 100 and methods of retail dispense and sale of bulk products. It will be recognized that further implementations may be arrived at by combining features disclosed with respect to any of FIGS. 1-5 while remaining within the scope of the present disclosure.

FIG. 2 presents an example of implementation of the system 100 and a method of bulk dispensing. In the example of FIG. 2, a bulk gravity dispenser 102 may be manually operated with actuation detection, automated with a proximity sensor and electromechanical actuation of the valve within the dispenser to dispense a metered amount of the bulk product from the hopper 105. In an automated dispense operation, lighting associated with the dispenser 102 gives the user feedback by illuminating one or more lights to indicate for example, when the dispenser 102 is ready to accept a receptacle 116 in the possession of the customer to receive the dispensed bulk product when the receptacle 116 is in the proper position relative to the dispenser 102 to receive the dispensed bulk material, when the dispenser 102 is actively dispensing the bulk product, and when the dispense operation has been completed.

The user enters the bulk display area that includes a plurality of dispensers 102 and a retail endpoint 108. The user identifies the dispenser 102 of a desired bulk product and operates the dispenser 102, either manually or automatedly, to dispense bulk product from the hopper 105 into a consumer receptacle 116. In an example, a standardized consumer receptacle may eliminate the need for alternative tare procedures. Standardized receptacles may be made available at the bulk display area for use or purchase by the customer. In an alternative example, the customer provides receptacles already in their possession, for example to re-fill a receptacle. As explained herein, in such examples, a receptacle 116 already in the possession of a customer may be registered or pre-registered to inform the system with information about the receptacle.

The controller 104, either as part of the dispenser 102 or located in the fixture 106 and associated with multiple dispensers 102, establishes a communicative connection 128, either wired or wirelessly, to the retail endpoint 108. The controller 104 communicates a product identity in the exemplary form of a SKU/PLU to the retail endpoint 108. The communication of the product identity may be performed upon loading of a hopper 105 to the dispenser 102. In other examples, the communication of the product identity is provided each time that the dispenser 102 is actuated in a dispense procedure to communicate the occurrence of a dispense of the identified product by that dispenser 102. The retail endpoint 108 operates a graphical display 112 to visually present all of the received product identities of the products that have been dispensed by the dispensers in the system. A user brings the filled receptacle 116 to the retail endpoint 108 and selects the identified product from the list visually presented on the graphical display 112. The user then uses a scale 118 to weigh the product and operates a label printer 114 to print a label 115 with the product identification, a product weight (which may be a marked for trade weight), a price of the bulk product. Some or all of this information may be encoded in a bar code to facilitate in-person or self-checkout. Checkout may be completed by the user by brining the filled receptacle 116 with the printed label 115 to a checkout station 122, either in-person or self-checkout. The printed label 115 encoded with the SKU/PLU and the quantity (or estimated quantity), improves speed and quality of the checkout process.

After the user has printed the label 115, the graphical display 112 is refreshed to remove the associated product identification, leaving the visually presented list of the identified products which have been dispensed from the dispensers, but have not yet been weighed and labeled.

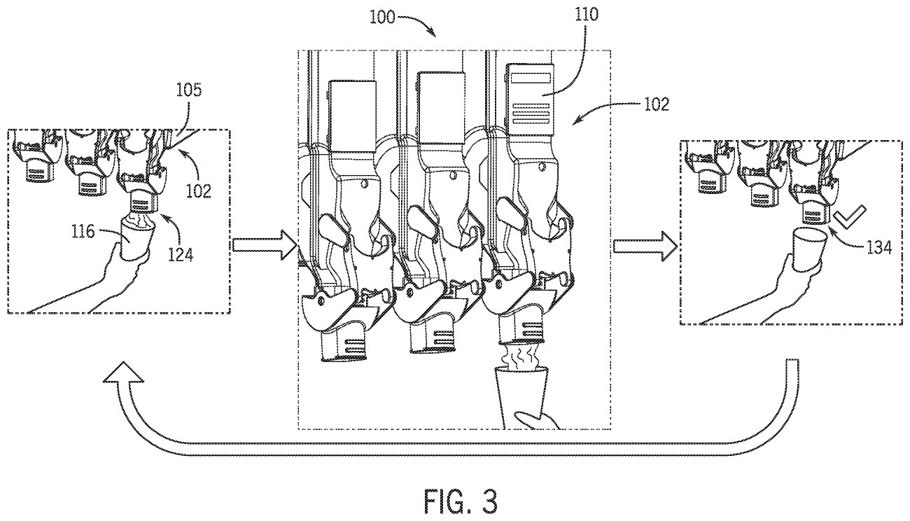

FIG. 3 presents an example of the operation of an automated dispense of the bulk material from a dispenser 102. In FIG. 3, each dispenser 102 includes a dedicated graphical display 110. As noted above, it will be recognized that each dispenser 102 may further include a controller, which may include a computer processor and be implemented as a single board computer (SBC). The controller may be integrated with the dispenser, may be housed in a support for the dispenser, or may be located in the fixture which holds the dispenser in the in-store display. The controller may support a single dispenser 102 or one controller may support multiple dispensers 102. In other examples, the controller may be multiple controllers that support multiple dispensers. The controller, which incorporates the features as described above with respect to FIG. 2, operates the graphical display 110 to visually present an identification of the bulk product within the dispenser, and a unit price for the bulk product. The graphical display 110 may further provide the visual indications of the dispensing operation, including dispensing or standby modes of operation. Additionally, the controller may operate the graphical display 110 to provide pricing and product details of the bulk product in the hopper 105 of the dispenser 102. Such information may be obtained by the controller from hopper identification provided by a user upon hopper replacement or upon set-up of the dispenser. In a further example, the hopper 105 may be self-identifying with an RFID or NFC communication capabilities to inform the controller with the identifying information of the contents of the hopper 105. The controller operates the graphical display 110 to coordinate with the identifying information provided by the hopper 105. In a still further example, the controller may operate the graphical display 110 to update pricing or product identification, or to present advertisements, coupons, or sale information.

A customer places the receptacle 116 in a dispense position relative to the dispenser 102 of the desired bulk product. A sensor 124, which may be a proximity sensor, an RF sensor, an NFC sensor, or other form of sensor, of the dispenser 102 detects positioning of the receptacle 116 and initiates a dispense operation to open the valve of the dispenser 102 to dispense the bulk product. During the dispense operation, the graphical display 110 may be operated to update with an estimated amount dispensed and an estimated total accumulated price. In an example of a continuous flow dispenser, the controller associated with the dispenser 102 may be provided with an estimated product mass and flow rate during the dispensing operation. The amount of time that the dispenser valve is open is used with the product weight and flow rate to calculate an estimated dispense amount. In an example of a fixed volume dispensing valve, each actuation of the valve dispenses a fixed volume. A visual indicator 134, for example one or more LEDs, may indicate to the user the end of dispense of a fixed volume portion. The user may move the receptacle 116 towards and away from the dispenser to dispense multiple fixed volume portions into the receptacle 116. Alternatively, the visual indication may be provided on the graphical display 110. The controller operates to count the dispense cycles. The controller further uses a predefined estimated weight for the fixed volume of the bulk product in combination with the counted dispense cycles and the unit price for the bulk product to increment the visually presented estimation.

As described above, for example with respect to FIG. 2, the identity of the dispensed product and optionally the occurrence of a dispense operation and the estimated dispense amount is provided to the weighing and labeling station. The inclusion of the estimated dispense amount can help the user to further identify which identification visually presented on the graphical display is associated with the user's purchase. In an example, the weighing and labeling station may only provide a label properly identifying the bulk product, which facilitates checkout of the bulk product on a marked for market scale associated with the cashier or self-checkout station. In another example, the weighing and labeling station includes a marked for market scale and the label is printed with the official market price. While the market amount and price may differ somewhat from the estimated amount and price, the estimated amount and price provides the user with a reasonable expectation of the market amount and price prior to labeling and purchase.

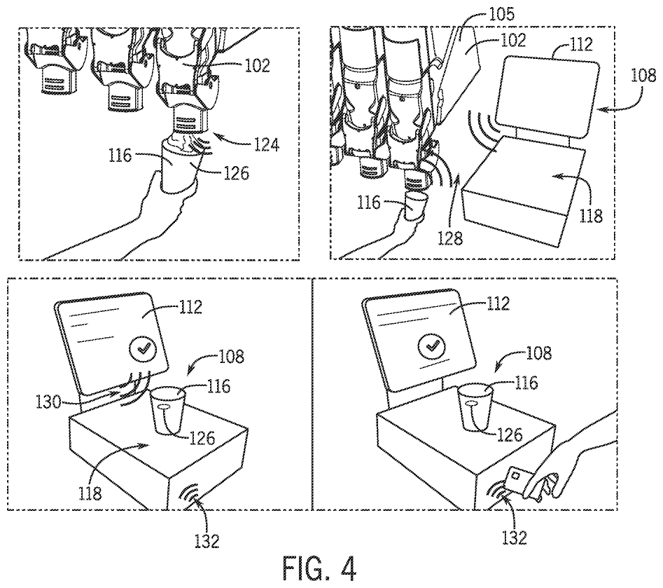

FIG. 4 presents another example of implementation of the system 100 and a method of bulk dispensing. In the example of FIG. 4, the receptacle 116 is provided with an RFID tag 126. The RFID tag 126 is encoded to identify the receptacle 116. It will be recognized that the RFID tag 126 may be another form of self-identifying and/or detectable conveyance of information, non-limiting examples being NFC or barcodes. In an example, the RFID tag 126 is encoded with information regarding the receptacle 116, e.g. a volume and/or a tare weight. In examples, the receptacles 116 may be standardized and provided for single use by a customer. However, in another example, the receptacles 116 are reusable either as part of a circular reusable customer receptacle ecosystem (whereby receptacles are used, a deposit paid, and returned for replacement and cleaning) or owned by the customer. If the receptacle 116 is owned by the customer, the receptacle 116 may be purchased and the RFID tag 126 with the associated receptacle information, integrated with the receptacle or a custom RFID tag 126 may be created which is encoded or tied to an ID database with the information regarding that individual receptacle. In still further examples, the RFID may encode an identification of the user themselves which may be used to personalize the user's experience, provide retail promotions, and enhance retail data gathered by the system.

In the example shown in FIG. 4, the dispensing operation performed by the dispenser 102 may proceed as in any of the examples described above. However, the sensor 124 of the dispenser 102 may read the information encoded in the RFID tag 126 of the receptacle 116 and provide this information to the controller. The controller may use this information either as the detection of the receptacle 116 to initiate an automated dispense or to otherwise enhance the operation of the dispenser 102. In one example, the customer may be presented with a personalized greeting or display content on the graphical display 110 upon recognition of the identifying information in the RFID tag 126. In another example, with a known volume of the receptacle, the dispenser may operate to dispense a “full volume” of the receptacle, or the controller may limit the operation of the dispenser 102 to not dispense an estimated amount that exceeds the known receptacle volume.

Upon completion of the dispense operation, the controller of the dispenser 102 may further operate to send both the identity (SKU/PLU) of the dispensed product, but also the identity (from the RFID tag) of the receptacle into which it was dispensed to the retail endpoint 108 through the communicative connection 128. When the user takes the filled receptacle 116 to the labeling and weighing station 108, the user experience can be streamlined, as the retail endpoint 108 can include a corresponding reader 130 to read the RFID tag and associate the receptacle 116 to the dispense information received from the dispensers. It will be recognized that the reader 130 corresponds to the manner in which the information is encoded in the tag 126, e.g. RFID, NFC, barcode, etc. In such examples, the user thus need not themselves select or otherwise identify the dispensed bulk product to the retail endpoint 108.

In a still further example of FIG. 4, the retail endpoint 108 may include a payment system 132, e.g. credit card or mobile NFC reader, so that the user can complete a self-checkout of the dispensed bulk products. In a still further related example, the RFID tag 126 is writable and the dispenser 102 writes to the RFID tag to identify the bulk product which has been dispensed into the receptacle 116. When the user transfers the filled receptacle 116 to the retail endpoint 108, the written to RFID tag 126 communicates the bulk product identification to the retail endpoint 108. Once home, the user may incorporate similar RFID readers in their kitchen or pantry to provide an identification of the stored bulk products and/or a date upon which the bulk product was purchased or an expiration date, if this information was also written to the RFID tag by the dispenser or the labeling/weighing station. Such features can assist a user in managing their home inventory of bulk products.

It will be recognized that still further examples, may incorporate or implement features as described above or similar thereto. In one example, the user possesses an identification, such as an RFID tag, barcode, QR barcode, or electronic transmitter/transponder. Upon dispensing product (either manually or automatically), the retail display dispensing system could record the purchasing user's identity and associate it to the SKU of the product purchased.

The customer ID and selected SKU information could then be transferred electronically via network or information technology systems to any number of aggregation points. Some examples might include a printer, where a label identifying the SKU of the product purchased could be automatically prepared for the identified user. Alternately, the data could be transferred to the point of sale (POS) (e.g. cashier station) for association of user, product SKU, and quantity at checkout. Finally, if such an identification system were combined with a legal for trade measurement system, the information could be transmitted to an electronic transaction (check-out) system such as a mobile or web application.

In an inversion of this model, each retail bulk dispensing bin could contain an electronic identification tag, such as an RFID tag, QR Code, Bar Code, or electronic transmitter/transponder, while the purchasing customer holds and activated the scanning/recording device. Upon dispensing product (either manually or automatically), the user held scanning device could record the identity of the product and associate it to the identity of the scanner and thereby the user who is holding it. The scanning device could be a device maintained by the retailer, or via a mobile or web application on a user-owned device, for example, a smartphone.

In either case, the user ID and selected SKU information could then be transferred electronically via network or information technology systems to any number of aggregation points as listed above including printers, POS systems, and mobile checkout systems.

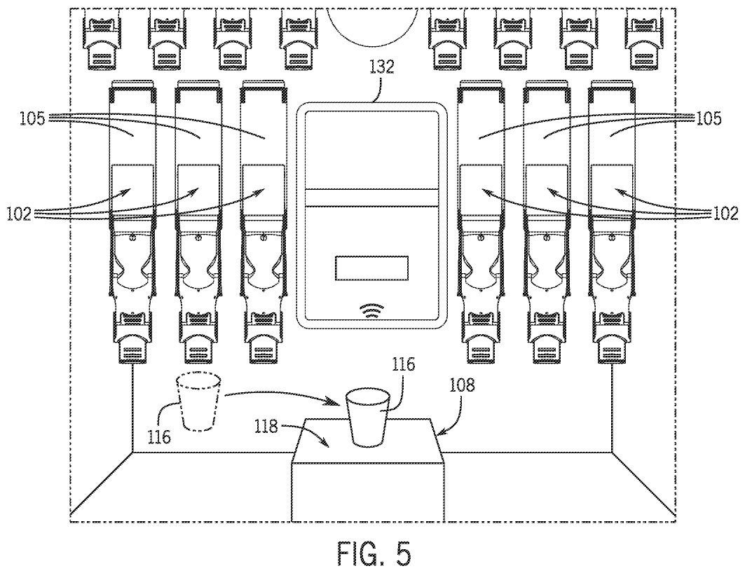

FIG. 5 presents a further example of implementation of the system 100 and a method of bulk dispensing. In the example of FIG. 5, a combined graphical display 132 replaces the functionality of previously described graphical displays 110 and 112. The combined graphical display is exemplarily provided centrally to the plurality of dispensers 102. A retail endpoint 108 is centrally located to the combined graphical display 132. The dispensers 102 may operate in the manners as described above, but the identification of the dispensed bulk product, the estimated dispense amount and the estimated price are presented on the combined graphical display 132 for operation of the dispensers 102 and the retail endpoint 108. After the bulk product is dispensed by a dispenser 102 into the receptacle 116, the user transitions the receptacle 116 to the scale 118 of the retail endpoint 108 to complete the dispensing process with the marked for market amount and price, and in conjunction with the display of the dispense information on the combined display 132. In a still further example, the retail endpoint 108 may further be integrated with payment functionality, for example as described above with respect to FIG. 4, so that the user can complete a self-checkout of the dispensed bulk products.

As described above, examples of the system as described herein further provide communication of the dispensing data to a retail data network. This retail data network may be local to a store, regionally within related stores, nor extend to a broader network of stores. The dispense data generated by the implementation of the systems and methods as described above, can further be used to improve retail and stockroom identification, measurement, and purchasing by providing the history and quantity of bulk products. With the purchase quantity history of goods and the origin distributors and producers of bulk foods to the store, an in stock quantity inventory may be calculated. Such systems could employ common information technologies such as Enterprise Resource Management and Planning platforms, databases etc., to track and analyze inventory, and consumption.

For automated bulk dispense and stock keeping systems, data regarding individual identification of the location and condition of bins on a display fixture may be required. Similarly, individually actuated bins may require some form of power supply to be routed to each, to power sensors actuators and embedded electronics. Bulk dispenser displays are often reconfigurable however and may therefore be subject to frequent rearrangement and service. In order to provide power to a display comprising multiple such bins, and to facilitate the easy aggregation of individual bin locations information by a centralized edge computer, a self-configuring network & bus wiring system is proposed. The system will consist of a plurality of wiring including at minimum, power rails, may also include data rails, or wiring may be combined into power and data rails in some cases. Further, power rails coupled with wireless communications might also be applicable. Within such a system individual dispensers may be able to connect to the power (and/or data) rail system at any point, or at any number of finite fixed positions, without the need for a separate electronic connection operation. That is there is an exposed terminal-socket system such that ‘snapping down’ or otherwise mechanically affixing the bin also engages the electrical contacts.

In an examples of the implementation of this system, a finite set of locations might be numbered, and the retail operator can associate the identity, contents, and/or status of a bin to its location on the display by manually entering this information into the central computer. In another example, the bin would contain some form of identification technology, such as a series of wire jumpers, a uniquely identifying frequency or resistance, a series of electrical or mechanical contacts, or an embedded computer, to signify some information about itself such as its contents SKU, its volume, its expiration date, etc. When snapped into the bus system above, the controlling ‘edge’ computer would gain access to this information and would be able to register the bin and its data for access by automation, checkout, and external data systems. In a still further example, the dispenser includes an integrated controller and is operable to self-configure, using an address claiming or registration scheme. Any number of registration schemes as commonly employed in computer networks might be used. In this way, once a ‘smart bin’ is installed, no further action is required by the retail operator to configure it for actuation or data communications.

It will be recognized that the present disclosure provides disclosure of multiple examples of systems and methods for bulk dispensing, and that these examples are not limiting on the scope of the present disclosure. It will be recognized that features from the above description, while not being explicitly shown or described as being used together, may be combined to form further examples while remaining within the scope of the present disclosure.

Citations to a number of references are made herein. The cited references are incorporated by reference herein in their entireties. In the event that there is an inconsistency between a definition of a term in the specification as compared to a definition of the term in a cited reference, the term should be interpreted based on the definition in the specification.

In the above description, certain terms have been used for brevity, clarity, and understanding. No unnecessary limitations are to be inferred therefrom beyond the requirement of the prior art because such terms are used for descriptive purposes and are intended to be broadly construed. The different systems and method steps described herein may be used alone or in combination with other systems and methods. It is to be expected that various equivalents, alternatives and modifications are possible within the scope of the appended claims.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A gravity-feed dispensing system comprising:
a hopper configured to hold a bulk material for dispense, the hopper comprising a hopper identifier, the hopper identifier encoding an identification of the bulk material in the hopper;
a gravity feed dispenser comprising a valve operable by an actuator assembly between open and closed conditions to selectively permit bulk material to pass from the hopper into a consumer receptacle;
a controller configured to receive an indication of a dispense of bulk material from the hopper and configured to receive the identification of the bulk material in the hopper; and
a retail endpoint configured to receive the indication of a dispense and the identification of the bulk material in the hopper and configured produce a sale indicator from the indication of the dispense and the identification of the bulk material in the hopper.

2. The gravity-feed dispensing system of claim 1, wherein the controller determines an estimated dispense amount and an estimated dispense cost.

3. The gravity-feed dispensing system of claim 2, wherein the identification of the bulk material in the hopper comprises a material density and a unit price.

4. The gravity-feed dispensing system of claim 1, wherein the retail endpoint comprises a scale configured to measure a weight of the bulk material in the consumer receptacle, wherein the sale indicator comprises the weight of the bulk material.

5. The gravity-feed dispensing system of claim 1, wherein the sale indicator comprises the identification of the bulk material and a sale price.

6. The gravity-feed dispensing system of claim 1, wherein the retail endpoint comprises a labeling station, the labeling station prints a label for the consumer receptacle with the sale indicator.

7. The gravity-feed dispensing system of of claim 1, wherein the retail endpoint comprises an endpoint graphical display configured to visually present the indication of the dispense, the identification of the bulk material, and the sale indicator.

8. The gravity-feed dispensing system of claim 1, wherein the hopper identifier comprises a hopper RFID tag that is encoded with the identification of the bulk material within the hopper.

9. The gravity-feed dispensing system of claim 1, wherein the consumer receptacle comprises a receptacle RFID tag.

10. The gravity-feed dispensing system of claim 1, wherein the controller references a lookup table with the hopper identifier to determine identification of the bulk material in the hopper.

11. The gravity-feed dispensing system of claim 1, wherein the gravity feed dispenser comprises a sensor configured to detect an operational state of the valve, and the controller is communicatively connected to the sensor and the operational state of the valve is the indication of a dispense of bulk material from the hopper.

12. The gravity-feed dispensing system of claim 1, further comprising a plurality of hoppers, the plurality of hoppers comprising the hopper, each hopper of the plurality of hoppers being interchangeably connectable to the gravity feed dispenser.

13. The gravity-feed dispensing system of claim 1, further comprising a dispenser graphical display, wherein the controller is configured to calculate an estimated price using the indication of a dispense and the identification of the bulk material in the hopper, and the controller is configured to operate the graphical display to visually present the estimated price.

14. The gravity-feed dispensing system of of claim 1, wherein the valve is configured to dispense a nominal fixed volume of bulk material with each dispense cycle of the valve, each dispense cycle comprising an open condition and a closed condition and the controller is configured to determine an estimated dispense amount using the nominal fixed volume and a count of a number of dispense cycles of the valve.

15. The gravity-feed dispensing system of claim 1, further comprising a retail data network wherein the controller provides dispense data to the retail data network.

16. The gravity-feed dispensing system of claim 9, wherein the retail endpoint is configured to write the sale indicator to the receptacle RFID tag.

17. The gravity-feed dispensing system of claim 9, wherein the receptacle RFID tag is configured to be written to and the dispenser writes to the receptacle RFID tag to encode the receptacle RFID tag with the identification of the bulk material.

18. The gravity-feed dispensing system of claim 17, wherein the retail endpoint is configured to read the receptacle RFID tag to receive the indication of a dispense and the identification of the bulk material.

19. The gravity-feed dispensing system of claim 9, wherein the receptacle RFID tag is encoded with an identification of a tare weight of the consumer receptacle.

20. The gravity-feed dispensing system of claim 14, wherein the controller further monitors a remaining inventory of the bulk material in the hopper by decrementing the nominal fixed volume from an initial hopper volume for each determined dispense cycle of the valve.

21. The gravity-feed dispensing system of claim 5, wherein the sale indicator is provided to a mobile computing device.
